(19) United States
(12) Patent Application Publication
(10) Pub. No.: US 2003/0182418 A1
(43) Pub. Date: Sep. 25, 2003

(54) Monitoring circuit cards of electronic systems technical field

(75) Inventors: David Feldman, Natania (IL); Amir Sharon, Ramat-Hasharon (IL); Katz Meir, Kefar Saba (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/102,801

(22) Filed: Mar. 21, 2002

(51) Int. Cl. G06F 15/173

(52) U.S. Cl. 709/224

(57) ABSTRACT

Methods for monitoring a plurality of electronic circuit cards of an electronic system are provided. An embodiment of the method includes collecting a plurality of messages at one of the plurality of electronic circuit cards. The plurality of messages includes a message from one or more of the plurality of electronic circuit cards. Transmitting the plurality of messages from the one of the plurality of electronic circuit cards to a monitor located externally to the electronic system is also included in the method. The method further includes selectively filtering the plurality of messages at the monitor, whereby producing a plurality of filtered messages.

### TECHNICAL FIELD

The present invention relates generally to the field of electronics and, in particular, to monitoring circuit cards of electronic systems.

### BACKGROUND

Many electronic systems, such as telecommunications systems or the like, include a number of electronic circuit cards. For monitoring purposes, many of these cards generate messages about their operation via one or more software packages loaded on the cards for providing functionality to the cards. Many of these cards have insufficient memory for storing the messages, so the messages have to be downloaded as they are generated to a monitor, such as a personal computer, located remotely to the electronic system. In many electronic systems, however, the cards do not have external access ports for downloading the messages to the personal computer. Moreover, in some instances, many of the messages generated by the cards are irrelevant, for example, when looking for specific problems, and have to be manually sorted through in order to find the messages of interest. This is time consuming and complicates the task of finding the messages of interest.

For the reasons stated above, and for other reasons stated below that will become apparent to those skilled in the art upon reading and understanding the present specification, there is a need in the art for alternatives for monitoring a number of electronic circuit cards of electronic systems.

### SUMMARY

The above-mentioned problems with monitoring electronic circuit cards of electronic systems and other problems are addressed by embodiments of the present invention and will be understood by reading and studying the following specification. Embodiments of the present invention provide methods for monitoring a plurality of electronic circuit cards of electronic systems.

More particularly, in one embodiment, a method for monitoring a plurality of electronic circuit cards of an electronic system is provided. The method includes collecting a plurality of messages at one of the plurality of electronic circuit cards. The plurality of messages includes a message from one or more of the plurality of electronic circuit cards. Transmitting the plurality of messages from the one of the plurality of electronic circuit cards to a monitor located externally to the electronic system is also included in the method, as is displaying the plurality of messages at the monitor.

In another embodiment, a method for monitoring a plurality of electronic circuit cards of an electronic system is provided. The method includes collecting a plurality of messages at one of the plurality of electronic circuit cards. The plurality of messages includes a message from one or more of the plurality of electronic circuit cards. Transmitting the plurality of messages from the one of the plurality of electronic circuit cards to a monitor located externally to the electronic system is also included in the method. The method further includes selectively filtering the plurality of messages at the monitor, whereby producing a plurality of filtered messages.

In still another embodiment, a method is provided for monitoring a plurality of electronic circuit cards of an electronic system. The method includes generating one or more messages, each having a message-identifier, at each of the plurality of electronic circuit cards, whereby producing a plurality of messages. The method includes collecting the plurality of messages at one of the plurality of electronic circuit cards. Moreover, the method includes transmitting the plurality of messages from the one of the plurality of electronic circuit cards to a monitor located externally to the electronic system. The method further includes selectively filtering the plurality of messages at the monitor, whereby producing a plurality of filtered messages. Displaying the plurality of filtered messages at the monitor is also included in the method.

### BRIEF DESCRIPTION OF THE DRAWINGS

FIG. 1 illustrates an electronic system and a monitor according to an embodiment of the present invention.

FIG. 2 illustrates a message-display window according to another embodiment of the present invention.

FIG. 3 illustrates a filter window according to yet another embodiment of the present invention.

FIGS. 4a and 4b are flowcharts illustrating operation of an electronic system according to another embodiment of the present invention.

FIG. 5 is a flowchart illustrating operation of a monitor according to another embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide for collecting a plurality of messages from one or more of a plurality of electronic circuit cards of an electronic system at one of the plurality of electronic circuit cards. The plurality of messages is transmitted from that electronic circuit card to a monitor located externally to the electronic system. Advantageously, this enables all of the electronic circuit cards to be monitored simultaneously from a single port of the electronic system and enables the messages to be stored in the monitor. Moreover, the embodiments provide for selectively filtering the messages at the monitor. This reduces the number of messages and enables only messages of interest to be displayed.

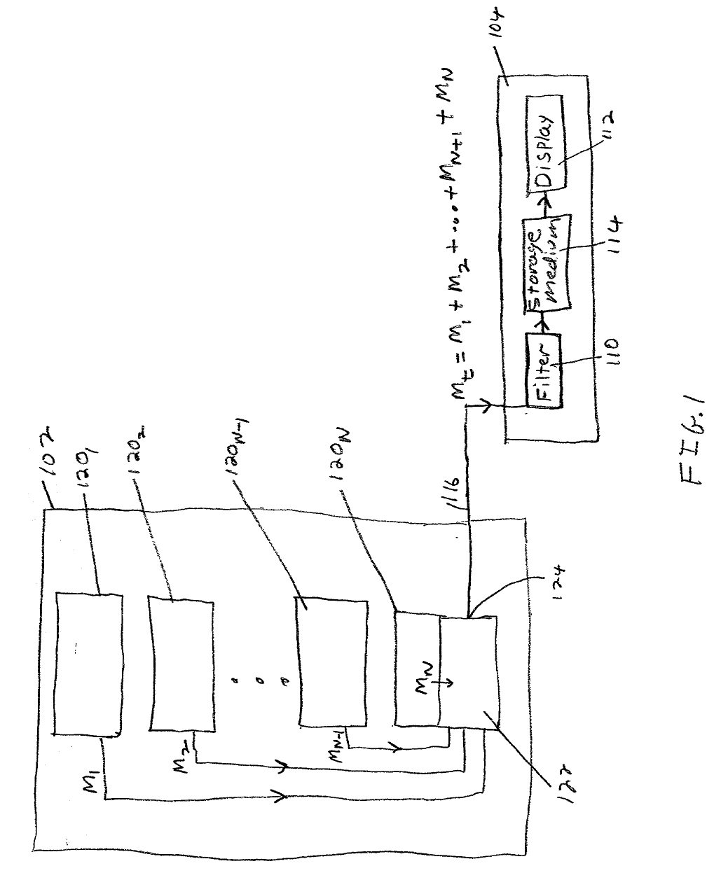

FIG. 1 illustrates a monitor 104, such as a personal computer or the like, communicatively coupled to an electronic system 102, such as a telecommunications system or the like, for monitoring electronic system 102 according to an embodiment of the present invention. In one embodiment, monitor 104 is external to electronic system 102. In another embodiment, monitor 104 is located remotely to electronic system 102. Messages Mₜ indicative of events occurring within electronic system 102 are generated within electronic system 102. Messages Mₜ are received from electronic system 102 at a monitor 104. In one embodiment, messages Mₜ are selectively filtered at filter 110, producing filtered messages M_{f}. Filtered messages M_{f} are stored in storage medium 114 and are displayed on a display 112.

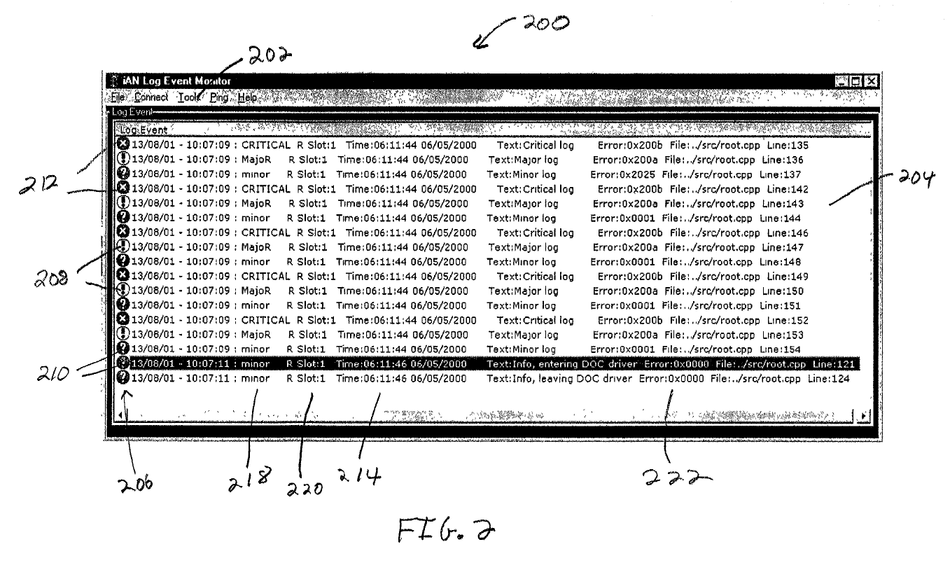

In one embodiment, display 112 is a display window of a personal computer monitor, such as message-display window 200 in FIG. 2. In some embodiments, message-display window 200 is a graphical user interface (GUI) window. In other embodiments, storage medium 114 is a hard drive or other computer-usable storage medium that can be fixedly or removably attached to monitor 104, e.g., magnetic media, optical media, read only memory (ROM), random access memory (RAM), electrically erasable programmable read only memory (EEPROM), flash memory, or other nonvolatile storage media.

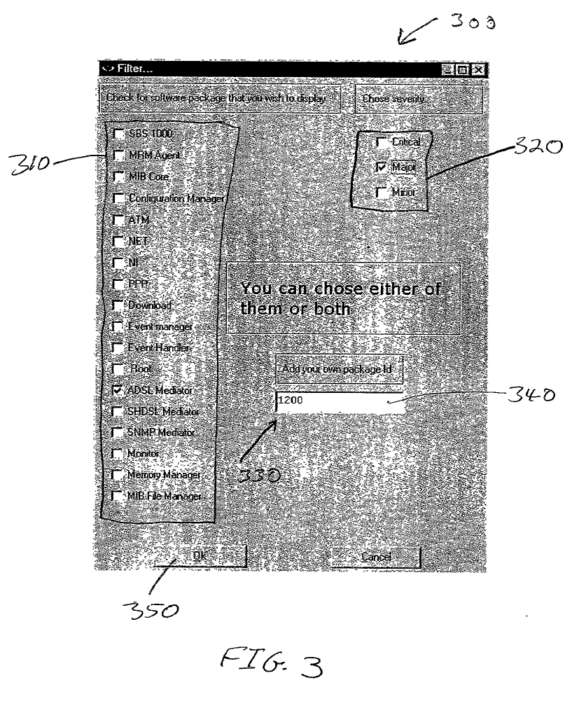

In one embodiment, filter 110 is embedded as machine-readable instructions, such as a software program, stored on a machine-readable medium, such as a hard drive, CD-ROM, network drive, or other appropriate machine-readable medium. In another embodiment, the software program includes multiple modules or objects for causing filter 110 to filter messages Mₜ. The type of computer programming languages used to write the software program may vary between procedural code type languages to object oriented languages. Filtering is selected from a filter window 300 (shown in FIG. 3). In one embodiment, filter window 300 is displayed by selecting it from a tools pull-down menu 202 of message-display window 200.

An interface 116 communicatively couples electronic system 102 and monitor 104. In various embodiments, interface 116 is a wireless interface, e.g., Infrared Data Association (IrDA) or BLUETOOTH, a hardwire interface, such as RS-232, asynchronous serial port, Universal Serial Bus, or the like. In some embodiments, interface 116 includes an Internet, local area network (LAN) connection, or the like.

Messages Mₜ, include messages M₁ to messages M_{N} respectively generated within electronic circuit cards 120₁ to 120_{N}, such as electronic circuit cards of a remote unit or central office of a telecommunications system or the like. In one embodiment, each of circuit cards 120 has functional electronic circuitry. In various embodiments, each of electronic circuit cards 120₁ to 120_{N} includes one or more software programs stored on a machine-readable medium for providing functionality to the corresponding one of each of electronic circuit cards 120₁ to 120_{N}. In some embodiments, the software programs are stored as embedded software modules running on the functional electronic circuitry of electronic circuit cards 120.

In one embodiment, the one or more software programs of each of electronic circuit cards 120 generate the messages of the corresponding electronic circuit card. Each of messages M₁ to messages M_{N} provides information about the operation of one of electronic circuit cards 120, such as the operation of one of the software programs, functional electronic circuits, or the like. For example, each of messages M₁ provides information about the operation of electronic circuit card 120₁, each of messages M₂ provides information about the operation of electronic circuit card 120₂ of electronic system 102, etc. In one embodiment, one or more of messages M₁ to messages M_{N} is an alarm or other error message.

Each of messages M₁ to messages M_{N} has a message-identifier. In one embodiment, the message-identifier is attached to a message by a software program of the respective electronic circuit card, such as the software program that generated the message. In some embodiments, the message-identifier includes a package-identification (package-ID), such as a number. In other embodiments, the package-ID corresponds to the electronic circuit card 120 that generated the message. For example, in one embodiment, the package-ID corresponds the location of the electronic circuit 120 within electronic system 102, such as a slot. In another embodiment, the message-identifier also includes a level-of-importance indicator for indicating a level-of-importance of the message, such as a severity, e.g., “minor”, “major”, and “critical”. In yet another embodiment, the message-identifier further includes a source indicator for indicating the source of the message, e.g., the software program that generated the message.

Each of messages M₁ to messages M_{N} is collected at a collector 122 of electronic circuit card 120_{N} to form messages Mₜ=messages (M₁+M₂+ . . . +M_{N-1}+M_{N}) that are output to monitor 104 via a port 124 communicatively coupled to monitor 104 by interface 116. In one embodiment, collector 122 is a set of machine-readable instructions, such as a software program, stored on a machine-readable medium and run on the functional electronic circuitry of electronic circuit card 120_{N}.

Messages Mₜ are selectively filtered according to the message-identifier of each of messages M₁ to messages M_{N}. In one embodiment, filtering is selected from filter window 300 of FIG. 3. Filter window 300 includes source filtering options 310, level-of-importance filtering options 320, and package-ID filtering options 330. Source filtering options 310 correspond to names of possible sources of messages, e.g., software or hardware, one or more of which resides on one or more of electronic circuit cards 120. Moreover, the source indicator of the message-identifier corresponds to one of source filtering options 310. Selecting one or more of source filtering options 310, for example, by placing a check mark next to the respective source filtering options 310, causes filter 110 to pass messages having source indicators corresponding to the selected source filtering options 310, only.

Level-of-importance filtering options 320, in one embodiment, include the severities “minor”, “major”, and “critical”. Moreover, the level-of-importance indicator of the message-identifier corresponds to one of level-of-importance filtering options 320. Selecting one or more of level-of-importance filtering options 320, for example, by placing a check mark next to the respective software-package filtering options 310, causes filter 10 to pass messages having level-of-importance indicators corresponding to the selected level-of-importance filtering options 320, only. Package-ID filtering options 330 are selected, for example, by entering one or more package-IDs, such as one or more numbers, in box 340 of filter window 300. Entering one or more package-IDs causes filter 110 to pass messages having those package-IDs, only.

An example of one embodiment of filtering messages Mₜ is illustrated in filter window 300. This example includes selecting one of source filtering options 310, such as asymmetric digital subscriber line (ADSL) Mediator, selecting one of level-of-importance filtering options 320, such as “major” severity, and entering one package-ID 330 in box 340, such as 1200. Filtering is initiated, in one embodiment, by selecting indicium 350 of filter window 300, such as “ok”. This causes filter 110 to pass messages Mₜ having a message-identifier with a source indicator corresponding to ADSL Mediator, a level-of-importance indicator corresponding to “major” severity, and a package-ID of 1200, only. In this embodiment, filtered message M_{f} is generated within one of electronic circuit cards 120, e.g., corresponding package-ID 1200. The filtered messages M_{f} all have “major” severity and are all generated by the ADSL Mediator software program.

In another embodiment, no filtering options are selected. In this embodiment, filtered messages M_{f}=messages Mₜ, and each of messages Mₜ is stored as it is received in storage medium 114 and displayed on display 112.

An example of an embodiment of a log 204 of filtered messages M_{f} is displayed on message-display window 200 of FIG. 2. A column 206 of log 204 displays symbols denoting levels-of-importance, such as severities 320, of filtered messages M_{f}. For example, symbols 208, such as exclamation points, denote “major” severities, symbols 210, such as question marks, denote “minor” severities, and symbols 212, such as Xs, denote “critical” severities. In some embodiments, symbols 208, 210, and 212 are color coded, for example, respectively using yellow, green, and red. Column 214 includes the date and time of when events corresponding to filtered messages M_{f} occurred. A column 218 displays the actual levels-of-importance, such severities 320, e.g., “minor”, “major”, and “critical”, of filtered messages M_{f}. A column 220 displays the location of the electronic circuit cards from which filtered messages M_{f} were generated. A column 222 displays messages filtered messages M_{f}.

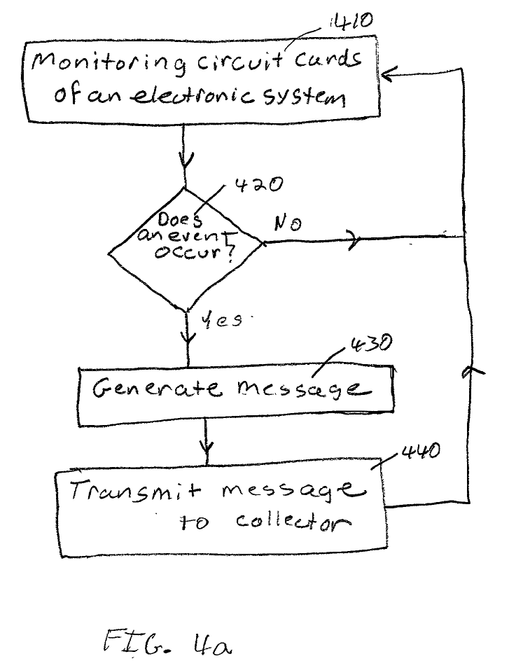

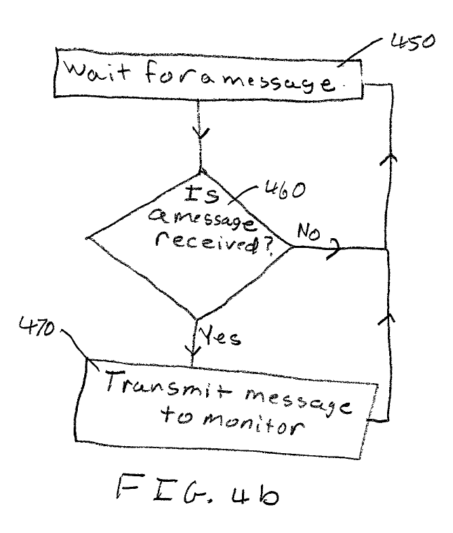

FIGS. 4a and 4b are flowcharts illustrating operation of electronic system 102 according to an embodiment of the present invention. At block 410 of FIG. 4a, the one or more software programs of each of electronic circuit cards 120 monitors the operation of the corresponding electronic circuit card for an event. If no event occurs, it is decided at decision block 420 to continue monitoring electronic circuit cards 120 at block 410. If an event does occur, it is decided at decision block 420 to generate a message indicative of the event at block 430. The generated message is then transmitted at block 440 to collector 122 of circuit card 120_{N}. At block 450 of FIG. 4b, collector 122 waits for a message generated by one or more of circuit cards 122. If no message is received, it is decided at decision block 460 to continue waiting for a message at block 450. If a message is received at collector 122, it is decided at decision block 460 to transmit the message to monitor 104 at block 470.

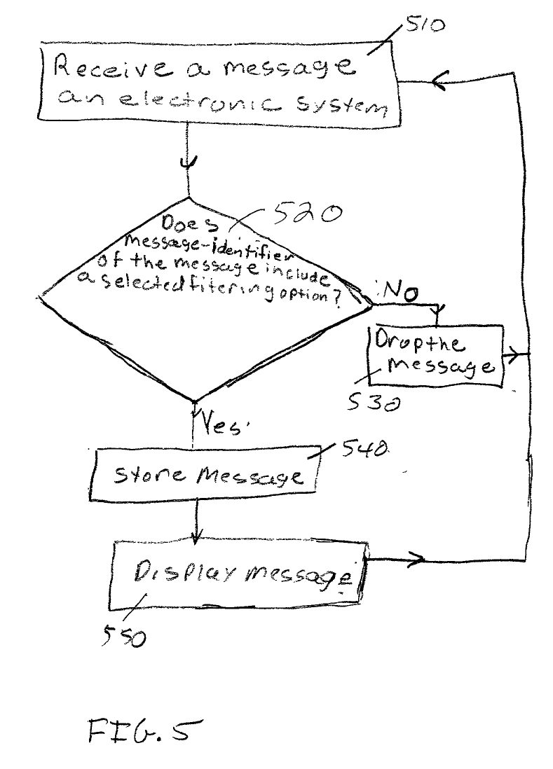

FIG. 5 is a flowchart illustrating operation of monitor 104 according to another embodiment of the present invention. Filter 110 receives a message from electronic system 102 at block 510. At decision block 520, the message indicator of the message is compared to selected filtering options. If the message indicator does not include any of the selected filtering options, the message is dropped at block 530, and the method continues at block 510 for another message. If the message indicator includes one or more of the selected filtering options, the message is stored in storage medium 114 at block 540 and displayed by display 112 at block 550. The method then continues at block 510 for another message.

### Conclusion

Embodiments of the present invention have been described. The embodiments provide for collecting a plurality of messages from one or more of a plurality of electronic circuit cards of an electronic system at one of the plurality of electronic circuit cards. The plurality of messages is transmitted from that electronic circuit card to a monitor located externally to the electronic system. Advantageously, this enables all of the electronic circuit cards to be monitored simultaneously from a single port of the electronic system and enables the messages to be stored in the monitor. Moreover, the embodiments provide for selectively filtering the messages at the monitor. This reduces the number of messages and enables only messages of interest to be displayed.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, in other embodiments, the monitor stores all messages prior to storage. It is manifestly intended that this invention be limited only by the following claims and equivalents thereof.

what is claimed is:

1. A method for monitoring a plurality of electronic circuit cards of an electronic system, the method comprising:
collecting a plurality of messages at one of the plurality of electronic circuit cards, the plurality of messages comprising a message from one or more of the plurality of electronic circuit cards;
transmitting the plurality of messages from the one of the plurality of electronic circuit cards to a monitor located externally to the electronic system; and
displaying the plurality of messages at the monitor.

2. The method of claim 1, further comprising storing the plurality of messages at the monitor.

3. The method of claim 2, wherein storing the plurality of messages at the monitor comprises storing the plurality of messages in a storage medium of a computer.

4. The method of claim 1, wherein displaying the plurality of messages at the monitor comprises displaying the plurality of messages on a display window of a computer monitor.

5. The method of claim 1, further comprising selectively filtering the plurality of messages at the monitor prior to displaying the plurality of messages.

6. The method of claim 5, wherein selectively filtering the plurality of messages comprises selecting a filtering option from a display window of a computer monitor.

7. The method of claim 5, further comprising storing the plurality of messages after selectively filtering the plurality of messages.

8. The method of claim 1, further comprising attaching a message-identifier to each of the plurality of messages.

9. A method for monitoring a plurality of electronic circuit cards of an electronic system, the method comprising:
collecting a plurality of messages at one of the plurality of electronic circuit cards, the plurality of messages comprising a message from one or more of the plurality of electronic circuit cards;
transmitting the plurality of messages from the one of the plurality of electronic circuit cards to a monitor located externally to the electronic system; and
selectively filtering the plurality of messages at the monitor, whereby producing a plurality of filtered messages.

10. The method of claim 9, wherein selectively filtering the plurality of messages comprises selecting a filtering option.

11. The method of claim 10, wherein selecting a filtering option comprises selecting the filtering option from a display window of a computer monitor.

12. The method of claim 10, wherein selecting a filtering option comprises selecting at least one or more filtering options from at least one of a plurality of source filtering options, a plurality of level-of-importance filtering options, and a plurality of package-ID filtering options.

13. The method of claim 9, further comprising attaching a message-identifier to each of the plurality of messages.

14. The method of claim 13, wherein attaching a message-identifier to each of the plurality of messages comprises attaching a level-of-importance indicator, a source indicator, and a package-ID to each of the plurality of messages.

15. The method of claim 9, wherein selectively filtering the plurality of messages comprises filtering the plurality of messages according to a message-identifier attached to each of the plurality of messages.

16. The method of claim 9, wherein selectively filtering the plurality of messages comprises filtering the plurality of messages according to at least one of a level-of-importance indicator, a source indicator, and a package-ID.

17. The method of claim 9, further comprising displaying the plurality of filtered messages.

18. The method of claim 17, wherein displaying the plurality of filtered messages comprises displaying the plurality of filtered messages on a display window of a computer monitor.

19. The method of claim 9, further comprising storing the plurality of filtered messages at the monitor.

20. The method of claim 19, wherein storing the plurality of filtered messages at the monitor comprises storing the plurality of filtered messages in a storage medium of a computer.

21. A method for monitoring a plurality of electronic circuit cards of an electronic system, the method comprising:
generating one or more messages, each having a message-identifier, at each of the plurality of electronic circuit cards, whereby producing a plurality of messages;
collecting the plurality of messages at one of the plurality of electronic circuit cards;
transmitting the plurality of messages from the one of the plurality of electronic circuit cards to a monitor located externally to the electronic system;
selectively filtering the plurality of messages at the monitor according to the message-identifier, whereby producing a plurality of filtered messages; and
displaying the plurality of filtered messages at the monitor.

22. The method of claim 21, wherein selectively filtering the plurality of messages at the monitor according to the message-identifier comprises filtering the plurality of messages according to at least one of a level-of-importance indicator, a source indicator, and a package-ID.

23. The method of claim 21, wherein displaying the plurality of filtered messages comprises displaying the plurality of filtered messages on a display window of a computer monitor.

24. The method of claim 21, further comprising storing the plurality of filtered messages at the monitor.

25. The method of claim 24, wherein storing the plurality of filtered messages at the monitor comprises storing the plurality of filtered messages in a storage medium of a computer.

26. An electronic module of an electronic system comprising:
functional electronic circuitry; and
a collector adapted to receive messages from the functional electronic circuitry and from functional circuitry of one or more other electronic modules of the electronic system, the collector is further adapted to transmit the messages to an external monitor.

27. The electronic module of claim 26, wherein the collector is a set of machine-readable instructions stored on a machine-readable medium of the electronic module.

28. The electronic module of claim 27, wherein the set of machine-readable instructions runs on the functional electronic circuitry of the electronic circuit module.

29. The electronic module of claim 26, further comprising a port adapted to communicatively couple the electronic module to the monitor.

30. A machine-readable medium comprising machine-readable instructions for causing a circuit to perform a method of operating an electronic system, the method comprising:
collecting a plurality of messages at one of a plurality of electronic circuit cards of the electronic system, the plurality of messages comprising a message from one or more of the plurality of electronic circuit cards; and
transmitting the plurality of messages from the one of the plurality of electronic circuit cards to a monitor located externally to the electronic system.

31. The method of claim 30, wherein collecting a plurality of messages at one of a plurality of electronic circuit cards of the electronic system comprises collecting the plurality of messages at a collector of the one of the plurality of electronic circuit cards.

32. A machine-readable medium comprising machine-readable instructions for causing a circuit to perform a method of operating an electronic circuit card of an electronic system, the method comprising:
monitoring the circuit card;
generating a message when an event occurs, wherein the message is indicative of the event; and
transmitting the event to a collector of the electronic system.

33. The method of claim 32, further comprising attaching a message-identifier to the message.

34. The method of claim 33, wherein attaching the message-identifier to the message comprises attaching a level-of-importance indicator, a source indicator, and a package-ID to the message.

35. A machine-readable medium comprising machine-readable instructions for causing a circuit to perform a method of operating a monitor, the method comprising:
receiving a message at the monitor from an electronic system, wherein the monitor is external to the electronic system;
displaying the message when a message-identifier of the message includes one or more selected filtering options; and
dropping the message when the message-identifier of the message does not include one or more selected filtering options.

36. The method of claim 35, wherein displaying the message comprises displaying the message on a display window of a computer monitor.

37. The method of claim 35, further comprising storing the message.

38. The method of claim 35, wherein storing the message comprises storing the message in a storage medium of a computer.
